(19) United States
(12) Patent Application Publication
(10) Pub. No.: US 2025/0300459 A1
(43) Pub. Date: Sep. 25, 2025

(54) CONNECTOR, POWER SUPPLY SYSTEM, AND CONTROL METHOD

(71) Applicant: SUNGROW (SHANGHAI) CO., LTD., Shanghai (CN)

(72) Inventors: Di LIU, Shanghai (CN); Yaqi WU, Shanghai (CN); Guohua XIANG, Shanghai (CN); Jiaoli LI, Shanghai (CN); Yeming GE, Shanghai (CN)

(21) Appl. No.: 19/008,680

(22) Filed: Jan. 3, 2025

(30) Foreign Application Priority Data
Mar. 21, 2024 (CN) 202410331278.0

(51) Int. Cl. H02J 3/00

(52) U.S. Cl. CPC H02J 3/007; H02J 2300/10; H02J 2300/24

(57) ABSTRACT

A connector, a power supply system, and a control method are provided. The power supply system includes multiple power supply devices and a connector. The connector includes a load connection terminal and a selection unit. The load connection terminal is configured to be connected to a load. The selection unit includes an output terminal and multiple input terminals. Each of the power supply devices is connected to a corresponding one of the input terminals. The input terminals are electrically insulated from each other. The output terminal is connected to the load connection terminal. The selection unit enables a selection of at most one of the input terminals to be electrically connected to the output terminal, to cause at most one of the power supply devices to supply power to the load through the selection unit.

The present application claims priority to Chinese Patent Application No. 202410331278.0, titled “CONNECTOR, POWER SUPPLY SYSTEM, AND CONTROL METHOD”, filed on Mar. 21, 2024 with China National Intellectual Property Administration, which is incorporated herein by reference in its entirety.

### FIELD

The present disclosure relates to the technical field of power supply system, and more particularly, to a connector, a power supply system, and a control method.

### BACKGROUND

In the related art, a microgrid is a concept relative to a traditional large power grid. The microgrid refers to a network composed, based on a predetermined topological structure, of multiple distributed power supplies and loads related to the distributed power supplies. In the microgrid, a diesel power generator, a photovoltaic power generation system, and other power supply systems are usually provided to supply power to the loads.

However, in a current power supply system, there is a risk of mutual coupling among the diesel power generator, the photovoltaic power generation system or other power supply systems when power is supplied from the diesel power generator, the photovoltaic power generation system or other power supply systems; and electric insulation requirements between ports cannot be met, which results in a safety hazard of electric leakage.

### SUMMARY

Embodiments of the present disclosure provide a connector, a power supply system, and a control method.

A connector according to embodiments of the present disclosure is applied in a power supply system. The power supply system includes multiple power supply devices. The connector includes a load connection terminal and a selection unit. The load connection terminal is configured to be connected to a load. The selection unit includes an output terminal and multiple input terminals. Each of the multiple power supply devices is connected to a corresponding one of the multiple input terminals. The multiple input terminals are electrically insulated from each other. The output terminal is connected to the load connection terminal. The selection unit is configured to select at most one of the multiple input terminals to be in conduction with the output terminal, to cause at most one of the multiple power supply devices to supply power to the load through the selection unit.

In some embodiments, the selection unit includes multiple mutually exclusive switches. The connector further includes a control unit. Each of the multiple input terminals is connected to the output terminal by a corresponding one of the multiple mutually exclusive switches. The control unit is configured to control at most one of the multiple mutually exclusive switches to be turned on, to cause at most one of the multiple input terminals to be in conduction with the output terminal and cause at most one of the multiple power supply devices to supply power to the load through the selection unit.

In some embodiments, the selection unit further includes a power grid connection terminal. The power grid connection terminal is configured to be connected to a power grid. In response to all of the multiple mutually exclusive switches being turned off, the power grid connection terminal is in conduction with the load connection terminal. The control unit is configured to control all of the multiple mutually exclusive switches to be turned off, to cause the power grid connection terminal to be in conduction with the load connection terminal and cause the power grid to supply power to the load through the selection unit.

In some embodiments, the multiple mutually exclusive switches include N single pole double throw switches. N is a positive integer greater than 1. The N single pole double throw switches include single pole double throw switches S1 to SN. Each of the N single pole double throw switches includes a first terminal, a second terminal, and a third terminal. The first terminal of the single pole double throw switch S1 is connected to a corresponding one of the multiple input terminals, the second terminal of the single pole double throw switch S1 is connected to the output terminal, and the third terminal of the single pole double throw switch S1 is connected to the second terminal of the single pole double throw switch S2. The first terminal of the single pole double throw switch SN is connected to a corresponding one of the multiple input terminals, the second terminal of the single pole double throw switch SN is connected to the third terminal of the single pole double throw switch SN−1, and the third terminal of the single pole double throw switch SN is connected to the power grid connection terminal. The first terminal of the single pole double throw switch SM is connected to a corresponding one of the multiple input terminals, the second terminal of the single pole double throw switch SM is connected to the third terminal of the single pole double throw switch SM−1, the third terminal of the single pole double throw switch SM is connected to the second terminal of the single pole double throw switch SM+1. M is a positive integer greater than 1 and smaller than N. The control unit is configured to control each of the N single pole double throw switches to make the second terminal be in conduction with the first terminal or the third terminal.

A power supply system according to embodiments of the present disclosure includes multiple power supply devices and the connector according to any one of the embodiments described above.

In some embodiments, the power supply device is a photovoltaic power generation device or a diesel power generation device.

A control method according to embodiments of the present disclosure is applied in a power supply system. The power supply system includes multiple power supply devices and a connector. The connector includes a load connection terminal and a selection unit. The selection unit includes multiple input terminals and an output terminal. Each of the multiple power supply devices is connected to a corresponding one of the multiple input terminals. The multiple input terminals are electrically insulated from each other. The output terminal is connected to the load connection terminal. The control method includes: controlling at most one of the multiple input terminals to be in conduction with the output terminal, to cause at most one of the multiple power supply devices to supply power to a load through the selection unit.

In some embodiments, the selection unit further includes a power grid connection terminal configured to be connected to a power grid, and in response to all of the multiple input terminals being not in conduction with the output terminal, the power grid connection terminal is in conduction with the load connection terminal. The control method further includes: controlling each of the multiple input terminals to be not in conduction with the output terminal, to cause the power grid to supply power to the load through the selection unit.

In some embodiments, the control method further includes: obtaining a power supply priority of each of the multiple power supply devices; sequentially obtaining a power supply quantity of each of the multiple power supply devices based on the power supply priority of each of the multiple power supply devices until a target power supply device is determined, where the power supply device, with the power supply quantity greater than or equal to a predetermined power supply quantity, is determined as the target power supply device; and in response to that the target power supply device is determined, controlling one of the multiple input terminals corresponding to the target power supply device to be in conduction with the output terminal, to cause the target power supply device to supply power to the load through the selection unit.

In some embodiments, the control method further includes: obtaining a power supply quantity of each of the multiple power supply devices; determining that each of the multiple power supply devices is not a target power supply device, when the power supply quantity of each of the multiple power supply devices is smaller than a predetermined power supply quantity; and in response to that each of the multiple power supply devices is determined not to be the target power supply device, controlling each of the multiple input terminals to be not in conduction with the output terminal, to cause the power grid to supply power to the load through the selection unit.

Additional aspects and advantages of the embodiments of present disclosure will be provided at least in part in the following description, or will become apparent in part from the following description, or can be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions for the embodiments made with reference to the accompanying drawings.

FIG. 1 is a schematic diagram showing a connector and a power supply system according to an embodiment of the present disclosure.

FIG. 2 is a schematic diagram showing a selection unit according to a first embodiment of the present disclosure.

FIG. 3 is a schematic diagram showing the selection unit enables power supply of a first power supply device according to the first embodiment of the present disclosure.

FIG. 4 is a schematic diagram showing the selection unit enables power supply of an M-th power supply device according to the first embodiment of the present disclosure.

FIG. 5 is a schematic diagram showing the selection unit enables power supply of an N-th power supply device according to the first embodiment of the present disclosure.

FIG. 6 is a schematic diagram showing the selection unit enables power supply of a power grid according to the first embodiment of the present disclosure.

FIG. 7 is a schematic diagram showing a selection unit according to a second embodiment of the present disclosure.

FIG. 8 is a schematic flowchart illustrating a control method according to the first embodiment of the present disclosure.

FIG. 9 is a schematic diagram showing the selection unit enables power supply of a first power supply device according to the second embodiment of the present disclosure.

FIG. 10 is a schematic diagram showing the selection unit enables power supply of an M-th power supply device according to the second embodiment of the present disclosure.

FIG. 11 is a schematic flowchart illustrating a control method according to the first embodiment of the present disclosure.

FIG. 12 is a schematic diagram showing the selection unit enables power supply of a power grid according to the second embodiment of the present disclosure.

### DETAILED DESCRIPTION OF THE EMBODIMENTS

Embodiments of the present disclosure are described in detail below, which are illustrated in the accompanying drawings, where the same or similar reference numerals throughout represent the same or similar elements or elements with the same or similar functions. The embodiments described below with reference to the drawings are illustrative only, and are intended to explain rather than limit the present disclosure.

In the related art, a microgrid is a concept relative to a traditional large power grid. The microgrid refers to a network composed, based on a predetermined topological structure, of multiple distributed power supplies and loads related to the distributed power supplies. In the microgrid, a diesel power generator, a photovoltaic power generation system, and other power supply systems are usually provided to supply power to the loads.

However, in a current power supply system, there is a risk of mutual coupling among the diesel power generator, the photovoltaic power generation system or other power supply systems when power is supplied from the diesel power generator, the photovoltaic power generation system or other power supply systems; and electric insulation requirements between ports cannot be met, which results in a safety hazard of electric leakage.

Embodiments of the present disclosure provide a connector, a power supply system, and a control method. The power supply system includes multiple power supply devices and a connector. The connector includes a load connection terminal and a selection unit. The selection unit includes an output terminal and multiple input terminals. Each of the multiple power supply devices is connected to a corresponding one of the multiple input terminals. The output terminal is connected to the load connection terminal. The selection unit enables a selection of at most one of the multiple input terminals to be electrically connected to the output terminal, to cause at most one of the multiple power supply devices to supply power to the load through the selection unit. In addition, the input terminals may be electrically insulated by an insulation material, which avoids mutual coupling between the power supply devices, and reduces the safety hazard of electric leakage of the power supply system.

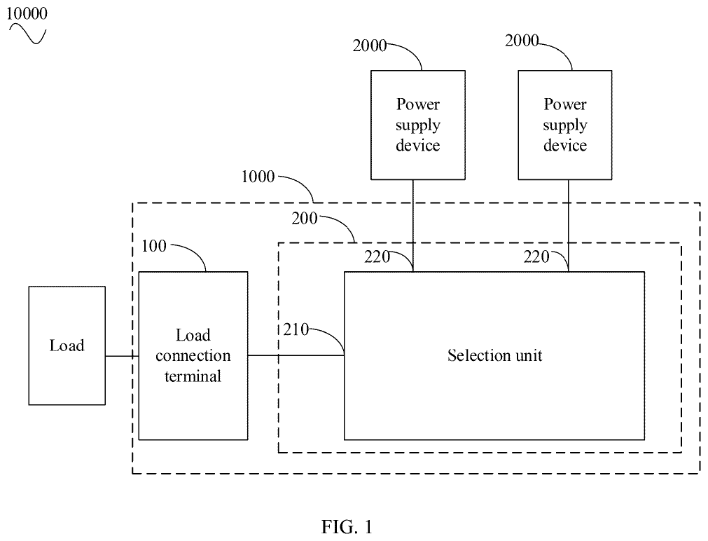

Referring to FIG. 1, an embodiment of the present disclosure provides a connector 1000 and a power supply system 10000. The power supply system 10000 includes multiple power supply devices 2000 and the connector 1000. The connector 1000 includes a load connection terminal 100 and a selection unit 200. The selection unit 200 includes an output terminal 210 and multiple input terminals 220. Each power supply device 2000 is connected to one corresponding input terminal 220. The output terminal 210 is connected to the load connection terminal 100. The selection unit 200 enables a selection of at most one of the multiple input terminals 220 to be electrically connected to the output terminal 210, to cause at most one of the multiple power supply devices 2000 to supply power to the load through the selection unit 200.

Coupling refers to a phenomenon in which inputs and outputs of two or more circuit elements or circuit networks closely cooperate with each other and interact with each other, and energy is transmitted from one side to another side of the two or more circuit elements or circuit networks through the interaction. For example, when two or more power supply devices 2000 are simultaneously connected to corresponding input terminals 220 respectively, one power supply device 2000 may supply power to another power supply device 2000, which results in a safety hazard of electric leakage.

The selection unit 200 is configured to select at most one input terminal 220 to be electrically connected to the output terminal 210, therefore the load connection terminal 100 cannot be simultaneously connected to multiple power supply devices 2000. In addition, the input terminals 220 may be electrically insulated by an insulation material, which avoids mutual coupling between the power supply devices 2000, and reduces the safety hazard of electric leakage of the power supply system 10000.

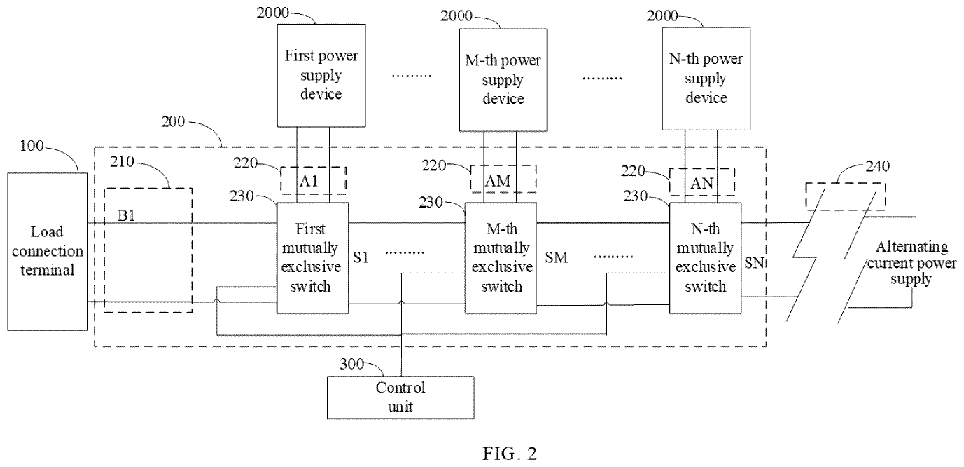

In some embodiments, referring to FIG. 2, the power supply devices 2000 may include a first power supply device 2000, a second power supply device 2000, and a third power supply device 2000 to an N-th power supply device 2000. N may be a positive integer greater than two. The input terminals 220 may include a first input terminal 220, a second input terminal 220, and a third input terminal 220 to an N-th input terminal 220. The first input terminal 220 is connected to the first power supply device 2000. The second input terminal 220 is connected to the second power supply device 2000. The third input terminal 220 is connected to the third power supply device 2000. The N-th input terminal 220 is connected to the N-th power supply device 2000.

In the first input terminal 220 to the N-th input terminal 220, an insulation layer is provided between every two input terminals 220, and the insulation layer may be made of an insulation material such as plastic and rubber, to achieve electric insulation between every two input terminals 220.

The selection unit 200 may realize an electrical connection between the output terminal 210 and any one input terminal 220, to cause any one power supply device 2000 to supply power to the load. For example, the output terminal 210 is electrically connected to the first input terminal 220, to cause the first power supply device 2000 to supply power to the load through the load connection terminal 100. In some embodiments, the output terminal 210 is electrically connected to an M-th input terminal 220, to cause an M-th power supply device 2000 to supply power to the load through the load connection terminal 100. The output terminal 210 is electrically connected to the N-th input terminal 220, to cause the N-th power supply device 2000 to supply power to the load through the load connection terminal 100. M may be any positive integer greater than 1 and smaller than N.

When the selection unit 200 selects the first input terminal 220 to be in conduction with the output terminal 210, the output terminal 210 is not in conduction with the second input terminal 220 to the N-th input terminal 220. When the selection unit 200 selects the N-th input terminal 220 to be in conduction with the output terminal 210, the output terminal 210 is not in conduction with the first input terminal 220 to an (N−1)-th input terminal 220. When the selection unit 200 selects the M-th input terminal 220 to be in conduction with the output terminal 210, the output terminal 210 is not in conduction with the first input terminal 220 to an (M−1)-th input terminal 220, and the output terminal 210 is not in conduction with an (M+1)-th input terminal 220 to the Nth input terminal 220. M may be any positive integer greater than 1 and smaller than N.

The output terminal 210 of the selection unit 200 is not simultaneously connected to two or more input terminals 220. The load connection terminal 100 is not simultaneously connected to two or more power supply devices 2000. The power supply devices 2000 are electrically insulated from each other, which avoids a risk of mutual coupling between the power supply devices 2000, and reduces the safety hazard of the power supply system 10000 during operation.

Referring to FIG. 2, the selection unit 200 includes multiple mutually exclusive switches 230. The connector 1000 includes a control unit 300. Each input terminal 220 is connected to the output terminal 210 by a corresponding one of the multiple mutually exclusive switch 230.

Embodiments of the present disclosure also provide a control method. In some embodiments, the control method may be performed by the control unit 300, that is, the control unit 300 is configured to perform the control method. In other embodiments, the control method may also be performed by other apparatuses or devices, and is not limited to being performed by the control unit 300. The control unit 300 may not be dedicated to performing the control method of the embodiments of the present disclosure, but may perform other functions and methods.

In some embodiments, the control method includes: controlling at most one of the multiple input terminals 220 to be in conduction with the output terminal 210, to cause at most one of the multiple power supply devices 2000 to supply power to the load through the selection unit 200.

The control unit 300 may be arranged in the selection unit 200 or outside the selection unit 200. The control unit 300 may control at most one of the multiple mutually exclusive switches 230 to be turned off, to achieve an electrical connection between at most one of the multiple input terminals 220 and the output terminal 210, to cause at most one of the multiple power supply devices 2000 to supply power to the load through the selection unit 200.

In some embodiments, the mutually exclusive switches 230 may include a first mutually exclusive switch 230 to an N-th mutually exclusive switch 230. The first input terminal 220 may be connected to the output terminal 210 by the first mutually exclusive switch 230. The M-th input terminal 220 may be connected to the output terminal 210 by an M-th mutually exclusive switch 230. The N-th input terminal 220 may be connected to the output terminal 210 by the N-th mutually exclusive switch 230.

The first mutually exclusive switch 230 may be a switch S1. The M-th mutually exclusive switch 230 may be a switch SM. The N-th mutually exclusive switch 230 may be a switch SN. The first input terminal 220 is connected to the switch S1 at a node A1. The M-th input terminal 220 is connected to the switch SM at a node AM. The N-th input terminal 220 is connected to the switch SN at a node AN. The output terminal 210 is connected to the load connection terminal 100 at a node B1.

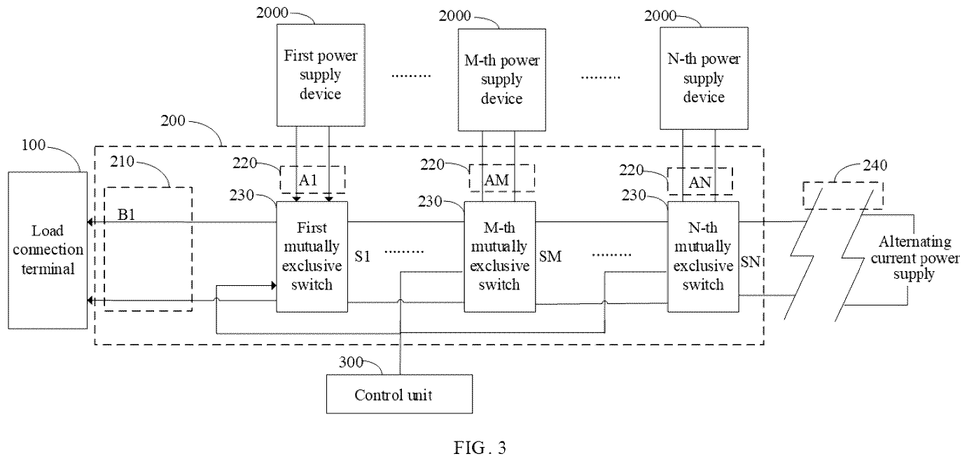

Referring to FIG. 3, the control unit 300 may control the switch S1 to be turned on and the switches S2 to SN to be turned off, to realize an electrical connection between the node A1 and the node B1, i.e., to realize the electrical connection between the first input terminal 220 and the output terminal 210, i.e., to realize the electrical connection between the first power supply device 2000 and the load connection terminal 100, to cause the first power supply device 2000 to supply power to the load through the load connection terminal 100.

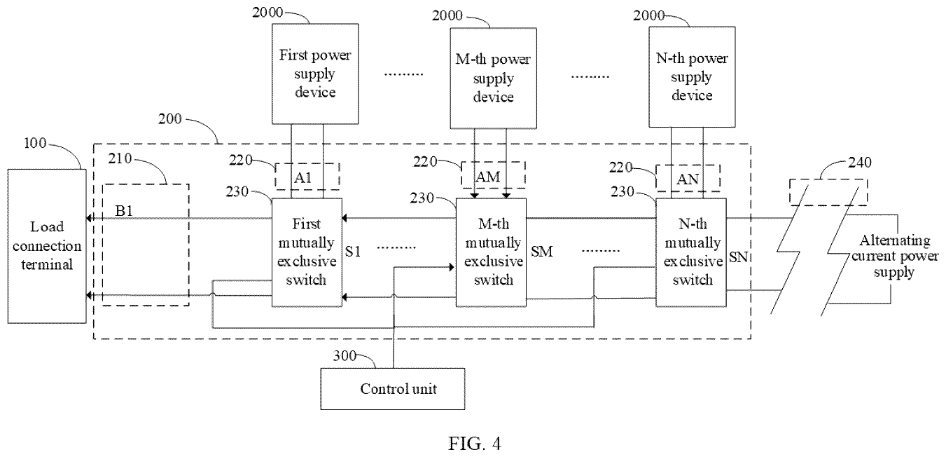

Referring to FIG. 4, the control unit 300 may control the switch SN to be turned on and the switches S1 to SN-1 to be turned off, to realize an electrical connection between the node AN and the node B1, i.e., to realize the electrical connection between the N-th input terminal 220 and the output terminal 210, i.e., to realize the electrical connection between the N-th power supply device 2000 and the load connection terminal 100, to cause the N-th power supply device 2000 to supply power to the load through the load connection terminal 100.

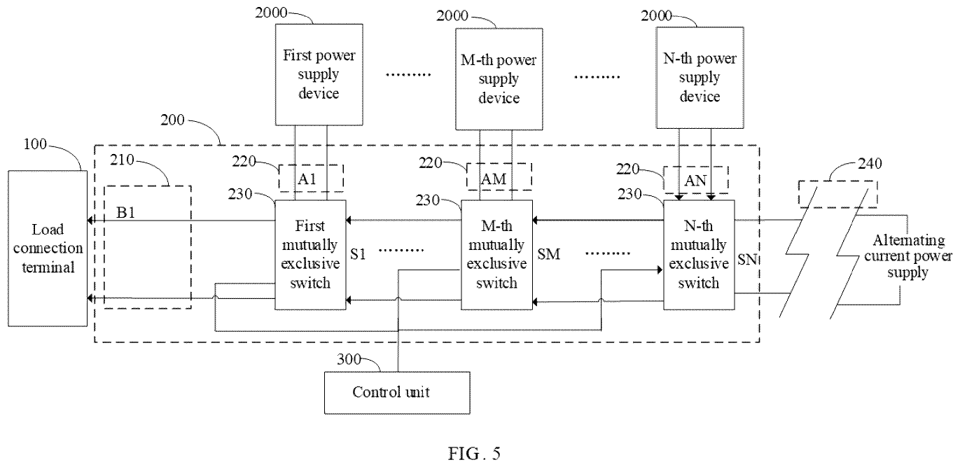

Referring to FIG. 5, the control unit 300 may control the switch SM to be turned on and the switches S1 to SM−1 and switches SM+1 to SN to be turned off, to realize an electrical connection between the node AM and the node B1, i.e., to realize the electrical connection between the M-th input terminal 220 and the output terminal 210, i.e., to realize the electrical connection between the M-th power supply device 2000 and the load connection terminal 100, to cause the M-th power supply device 2000 to supply power to the load through the load connection terminal 100.

Referring to FIG. 2, in some embodiments, the selection unit 200 includes a power grid connection terminal 240 configured to be connected to the power grid. In response to all of the multiple mutually exclusive switches 230 being turned off, the power grid connection terminal 240 is in conduction with the load connection terminal 100. The control unit 300 is configured to control all of the multiple mutually exclusive switches 230 to be turned off, to cause the power grid connection terminal 240 to be in conduction with the load connection terminal 100 and cause the power grid to supply power to the load through the selection unit 200.

The control method further includes: controlling each of the multiple input terminals 220 to be not in conduction with the output terminal 210, to cause the power grid to supply power to the load through the selection unit 200.

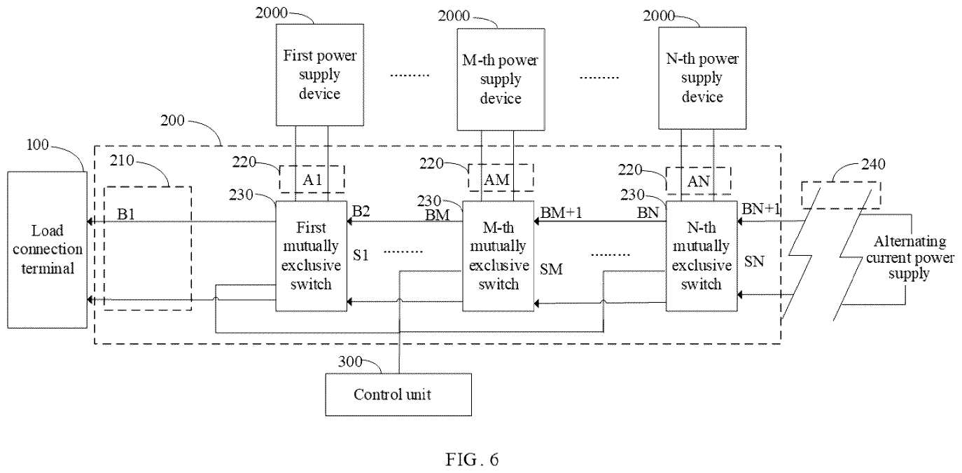

In some embodiments, referring to FIG. 6, the switch S1 may be connected to the output terminal 210 at the node B1, the switch SM may be connected to the switch SM−1 at a node BM, the switch SN may be connected to a switch SN−1 at a node BN, and the power grid connection terminal 240 may be connected to the switch SN at a node BN+1.

When the switch S1 is turned off, the node B1 is electrically connected to a node B2. When the switch SM is turned off, the node BM is electrically connected to a node BM+1. When the switch SN is turned off, the node BN is electrically connected to the node BN+1. When the switches S1 to SN each are turned off, the node B1 is electrically connected to the node BN+1.

The control unit 300 may control the switches S1 to SN to be turned off to realize the electrical connection between the node B1 and the node BN+1, i.e., to realize the electrical connection between the power grid connection terminal 240 and the output terminal 210, i.e., to realize the electrical connection between the power grid and the load connection terminal 100, to cause the power grid to supply power to the load through load connection terminal 100.

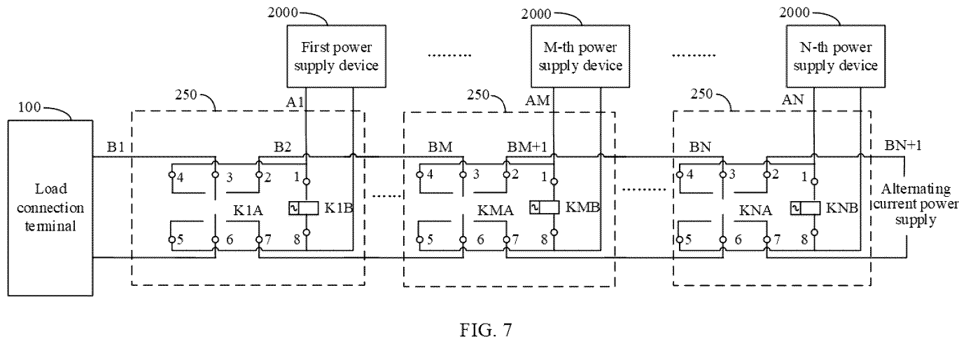

Referring to FIG. 7, in some embodiments, the multiple mutually exclusive switches 230 include N single pole double throw switches 250. N is a positive integer greater than 1. The N single pole double throw switches 250 include single pole double throw switches S1 to SN. Each of the N single pole double throw switches 250 includes a first terminal, a second terminal, and a third terminal. The first terminal of the single pole double throw switch S1 is connected to a corresponding one of the multiple input terminals 220, the second terminal of the single pole double throw switch S1 is connected to the output terminal 210, and the third terminal of the single pole double throw switch S1 is connected to the second terminal of a single pole double throw switch S2. The first terminal of the single pole double throw switch SN is connected to a corresponding one of the multiple input terminals 220, the second terminal of the single pole double throw switch SN is connected to the third terminal of a single pole double throw switch SN−1, and the third terminal of the single pole double throw switch SN is connected to the power grid connection terminal 240. The first terminal of a single pole double throw switch SM is connected to a corresponding one of the multiple input terminals 220, the second terminal of the single pole double throw switch SM is connected to the third terminal of a single pole double throw switch SM−1, and the third terminal of the single pole double throw switch SM is connected to the second terminal of a single pole double throw switch SM+1. M is a positive integer greater than 1 and smaller than N. The control unit 300 is configured to control each of the N single pole double throw switches 250 to make the second terminal be in conduction with the first terminal or the third terminal.

In some embodiments, the first single pole double throw switch 250 may include a switch K1A and a relay K1B, the M-th single pole double throw switch 250 may include a switch KMA and a relay KMB, and the N-th single pole double throw switch 250 may include a switch KNA and a relay KNB.

The first terminal of the first single pole double throw switch 250 may be contacts 4 and 5 of the switch K1A, the second terminal of the first single pole double throw switch 250 may be contacts 3 and 6 of the switch K1A, and the third terminal of the first single pole double throw switch 250 may be contacts 2 and 7 of the switch K1A. The contact 3 of the switch K1A may be connected to the contact 4 or the contact 2 of the switch K1A. The contact 6 of the switch K1A may be connected to the contact 5 or the contact 7 of the switch K1A. Two terminals of a coil of the relay K1B may be connected to contacts 1 and 8 of the switch K1A, respectively. When the coil of the relay K1B is de-energized, the contacts 2 and 3 of the switch K1A are connected to each other, and the contacts 6 and 7 of the switch K1A are connected to each other. When the coil of the relay K1B is energized, the contacts 3 and 4 of the switch K1A are connected to each other, and the contacts 5 and 6 of the switch K1A are connected to each other.

The first terminal of the M-th single pole double throw switch 250 may be contacts 4 and 5 of the switch KMA, the second terminal of the M-th single pole double throw switch 250 may be contacts 3 and 6 of the switch KMA, and the third terminal of the M-th single pole double throw switch 250 may be contacts 2 and 7 of the switch KMA. The contact 3 of the switch KMA may be connected to the contact 4 or the contact 2 of the switch KMA. The contact 6 of the switch KMA may be connected to the contact 5 or the contact 7 of the switch KMA. Two terminals of a coil of the relay KMB may be connected to contacts 1 and 8 of the switch KMA, respectively. When the coil of the relay KMB is de-energized, the contacts 2 and 3 of the switch KMA are connected to each other, and the contacts 6 and 7 of the switch KMA are connected to each other. When the coil of the relay KMB is energized, the contacts 3 and 4 of the switch KMA are connected to each other, and the contacts 5 and 6 of the switch KMA are connected to each other.

The first terminal of the N-th single pole double throw switch 250 may be contacts 4 and 5 of the switch KNA, the second terminal of the N-th single pole double throw switch 250 may be contacts 3 and 6 of the switch KNA, and the third terminal of the N-th single pole double throw switch 250 may be contacts 2 and 7 of the switch KNA. The contact 3 of the switch KNA may be connected to the contact 4 or the contact 2 of the switch KNA. The contact 6 of the switch KNA may be connected to the contact 5 or the contact 7 of the switch KNA. Two terminals of a coil of the relay KNB may be connected to contacts 1 and 8 of the switch KNA, respectively. When the coil of the relay KNB is de-energized, the contacts 2 and 3 of the switch KNA are connected to each other, and the contacts 6 and 7 of the switch KNA are connected to each other. When the coil of the relay KNB is energized, the contacts 3 and 4 of the switch KNA are connected to each other, and the contacts 5 and 6 of the switch KNA are connected to each other.

The first power supply device 2000 is connected to the contacts 4 and 5 of the switch K1A at the node A1, the M-th power supply device 2000 is connected to the contacts 4 and 5 of the switch KMA at the node AM, and the N-th power supply device 2000 is connected to the contacts 4 and 5 of the switch KNA at the node AN. The contacts 3 and 6 of the switch K1A are connected to the load connection terminal 100 at the node B1, the contacts 3 and 6 of the switch KMA are connected to contacts 4 and 5 of a switch KM−1A at the node BM, and contacts 3 and 6 of the switch KNA are connected to contacts 4 and 5 of a switch KN−1A at the node BN. The contacts 4 and 5 of the switch K1A are connected to contacts 3 and 6 of a switch K2A at the node B2, the contacts 4 and 5 of the switch KMA are connected to contacts 3 and 6 of a switch KM+1A at the node BM+1, and the contacts 4 and 5 of the switch KNA are connected to the power grid connection terminal 240 at the node BN+1.

The control unit 300 may control the contacts 3 and 4 of the switch K1A to be electrically connected and control the contacts 5 and 6 of the switch K1A to be electrically connected, to realize an electrical connection between the nodes A1 and B1, i.e., to realize the electrical connection between the first input terminal 220 and the output terminal 210, i.e., to realize the electrical connection between the first power supply device 2000 and the load connection terminal 100, to cause the first power supply device 2000 to supply power to the load through the load connection terminal 100.

The control unit 300 may control the contacts 2 and 3 of each of the switches K1A to KM−1A to be electrically connected and control the contacts 6 and 7 of each of the switches K1A to KM−1A to be electrically connected, to realize an electrical connection between the node B1 and the node BM. The control unit 300 may also control the contacts 3 and 4 of the switch KMA to be electrically connected and control the contacts 5 and 6 of the switch KMA to be electrically connected, to realize an electrical connection between the node AM and the node BM, and thus to realize an electrical connection between the node AM and node B1, i.e., to realize the electrical connection between the M-th power supply device 2000 and the load connection terminal 100, to cause the M-th power supply device 2000 to supply power to the load through the load connection terminal 100.

The control unit 300 may control the contacts 2 and 3 of each of the switches K1A to KNA to be electrically connected and control the contacts 6 and 7 of each of the switches K1A to KNA to be electrically connected, to realize an electrical connection between the node B1 and the node BN+1, i.e., to realize the electrical connection between the power grid connection terminal and the load connection terminal 100, to cause the power grid to supply power to the load through the load connection terminal 100.

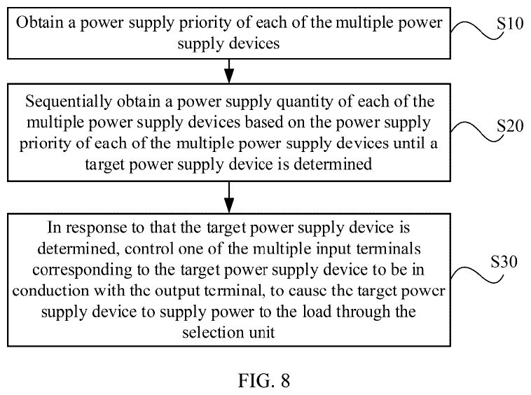

Referring to FIG. 8, in some embodiments, the control method includes operations at steps S10 to S30.

At step S10, a power supply priority of each of the multiple power supply devices 2000 is obtained.

At step S20, a power supply quantity of each of the multiple power supply devices 2000 is sequentially obtained based on the power supply priority of each of the multiple power supply devices 2000 until a target power supply device 2000 is determined. The power supply device 2000, with the power supply quantity greater than or equal to a predetermined power supply quantity, is determined as the target power supply device 2000.

At step S30, in response to that the target power supply device 2000 is determined, one of the multiple input terminals 220 corresponding to the target power supply device 2000 is controlled to be in conduction with the output terminal 210, to cause the target power supply device 2000 to supply power to the load through the selection unit 200.

In some embodiments, in the operation of the step S10, a priority of each power supply device 2000 may be determined based on the single pole double throw switch 250 connected to the power supply device 2000. For example, referring to FIG. 6, the first power supply device 2000 is connected to the switch K1A at the node A1, the M-th power supply device 2000 is connected to the switch KMA at the node AM, and the N-th power supply device 2000 is connected to the switch KNA at the node AN.

To realize the electrical connection between the first power supply device 2000 and the load connection terminal 100, the contacts 3 and 4 of the switch K1A are electrically connected to each other, and the contacts 5 and 6 of the switch K1A are electrically connected to each other, the contacts 2 and 3 of the switch K1A are not in conduction with each other, and the contacts 5 and 7 of the switch K1A are not in conduction with each other. That is, when the node A1 is electrically connected to the node B1, the node A1 is electrically disconnected from a node A2. When the node A1 is electrically disconnected from the node A2, the nodes A2 to AN each are electrically disconnected from the node B1. That is, when the first power supply device 2000 is electrically connected to the load connection terminal 100, each of the second power supply device 2000 to the N-th power supply device 2000 is electrically disconnected from the load connection terminal 100. Therefore, the first power supply device 2000 has a highest priority.

To realize the electrical connection between the M-th power supply device 2000 and the load connection terminal 100, the contacts 2 and 3 of each of the switches K1A to KM−1A are electrically connected to each other, and the contacts 5 and 7 of each of the switches K1A to KM−1A are electrically connected to each other. That is, after determining that the first power supply device 2000 to an (M−1)-th power supply device 2000 are electrically disconnected from the load connection terminal 100, the electrical connection between the M-th power supply device 2000 and the load connection terminal 100 can be realized. Therefore, the priority of each of the first power supply device 2000 to the (M−1)-th power supply device 2000 is greater than the priority of the M-th power supply device 2000.

After determining that the M-th power supply device 2000 is electrically connected to the load connection terminal 100, the contacts 3 and 4 of the switch KMA are electrically connected to each other, and the contacts 5 and 6 of the switch KMA are electrically connected to each other, and the contacts 2 and 3 of the switch KMA are not in conduction with each other, and the contacts 5 and 7 of the switch KMA are not in conduction with each other. That is, after determining that the M-th power supply device 2000 is electrically connected to the load connection terminal 100, each of an (M+1)-th power supply device 2000 to the N-th power supply device 2000 does not supply power to the load connection terminal 100. Therefore, the priority of the M-th power supply device 2000 is greater than the priority of each of the (M+1)-th power supply device 2000 to the N-th power supply device 2000.

In the operation of the step S20, the first power supply device 2000 to the N-th power supply device 2000 may be connected to corresponding detection circuits. The detection circuits may include a current detection circuit and a voltage detection circuit. The detection circuits may detect a power supply quantity of each of the first power supply device 2000 to the N-th power supply device 2000. For example, an electric meter may be connected to the first power supply device 2000 to the N-th power supply device 2000 to detect the power supply quantity of each of the first power supply device 2000 to the N-th power supply device 2000.

The control unit 300 may sequentially obtain the power supply quantity of each of the first power supply device 2000 to the N-th power supply device 2000 through the detection circuits. The power supply device 2000, with the power supply quantity greater than or equal to a predetermined power supply quantity, is determined as the target power supply device 2000.

The predetermined power supply quantity may a specific value. For example, the predetermined power supply quantity is W kWh. The predetermined power supply quantity may also be a percentage. For example, the predetermined power supply quantity is 80% of a total power quantity of the power supply device 2000.

The power supply quantity of the first power supply device 2000 is first obtained. When the power supply quantity of the first power supply device 2000 is greater than or equal to W kWh or is greater than or equal to 80% of the total power quantity of the first power supply device 2000, the first power supply device 2000 is determined as the target power supply device 2000, and there is no need to obtain the power supply quantity of each of the second power supply device 2000 to the N-th power supply device 2000.

When the power supply quantity of the first power supply device 2000 is smaller than W kWh or is smaller than 80% of the total power quantity of the first power supply device 2000, the power supply quantity of the second power supply device 2000 is obtained, and the operation is stopped until the target power supply device 2000 is determined.

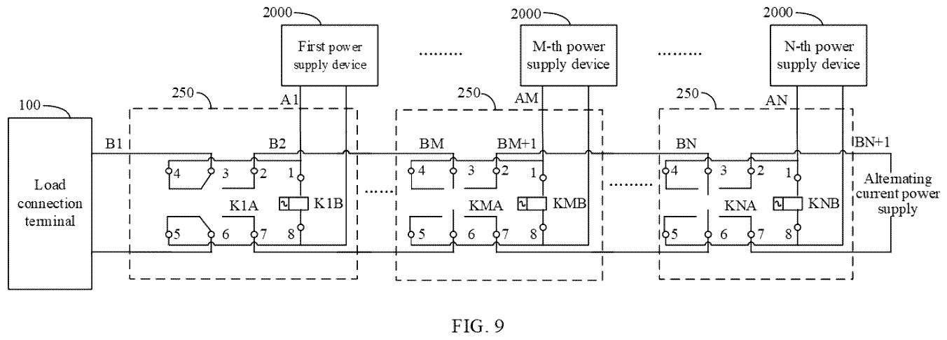

In the operation of the step S30, referring to FIG. 9, in response to the first power supply device 2000 being determined as the target power supply device 2000, the control unit 300 may control the contacts 3 and 4 of the switch K1A to be electrically connected to each other, the contacts 5 and 6 of the switch K1A to be electrically connected to each other, the contacts 2 and 3 of the switch K1A to be not in conduction with each other, and the contacts 5 and 7 of the switch K1A to be not in conduction with each other. That is, the node A1 is electrically connected to the node B1, and the node A1 is electrically disconnected from the node A2. That is, the first power supply device 2000 is electrically connected to the load connection terminal 100, and each of the second power supply device 2000 to the N-th power supply device 2000 is electrically disconnected from the load connection terminal 100.

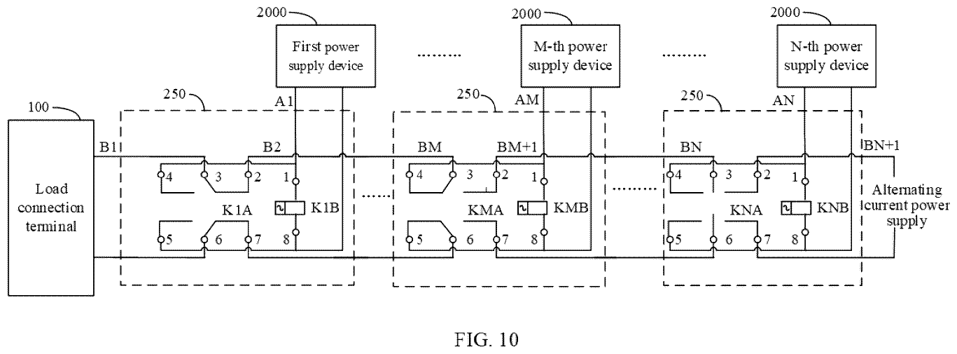

Referring to FIG. 10, in response to that each of the first power supply device 2000 to the (M−1)-th power supply device 2000 is determined not to be the target power supply device 2000, the control unit 300 may control the contacts 2 and 3 of each of the switches K1A to KM−1A to be electrically connected to each other, and the contacts 5 and 7 of each of the switches K1A to KM−1A to be electrically connected to each other. That is, each of the first power supply device 2000 to the (M−1)-th power supply device 2000 is not electrically connected to the load connection terminal 100. In response to that the M-th power supply device 2000 is determined as the target power supply device 2000, the control unit 300 may control the contacts 3 and 4 of the switch KMA to be electrically connected to each other, the contacts 5 and 6 of the switch KMA to be electrically connected to each other, the contacts 2 and 3 of the switch KMA to be not in conduction with each other, and the contacts 5 and 7 of the switch KMA to be not in conduction with each other. That is, each of the (M+1)-th power supply device 2000 to the N-th power supply device 2000 does not supply power to the load connection terminal 100.

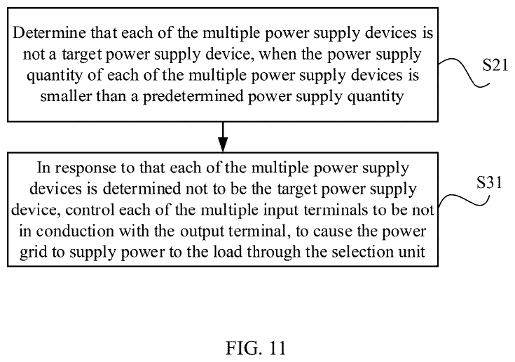

Referring to FIG. 11, in some embodiments, the control method further includes operations at steps S21 and S31.

At step S21, it is determined that each of the multiple power supply devices 2000 is not a target power supply device 2000 when the power supply quantity of each of the multiple power supply devices 2000 is smaller than the predetermined power supply quantity.

At step S31, in response to that each of the multiple power supply devices 2000 is determined not to be the target power supply device 2000, each of the multiple input terminals 220 is controlled to be not in conduction with the output terminal 210, to cause the power grid to supply power to the load through the selection unit 200.

In the operation of the step S21, when the power supply quantity of each of the first power supply device 2000 to the N-th power supply device 2000 is smaller than W kWh or smaller than 80% of the total power quantity of the first power supply device 2000, it is determined that each of the first power supply device 2000 to the N-th power supply device 2000 is not the target power supply device 2000.

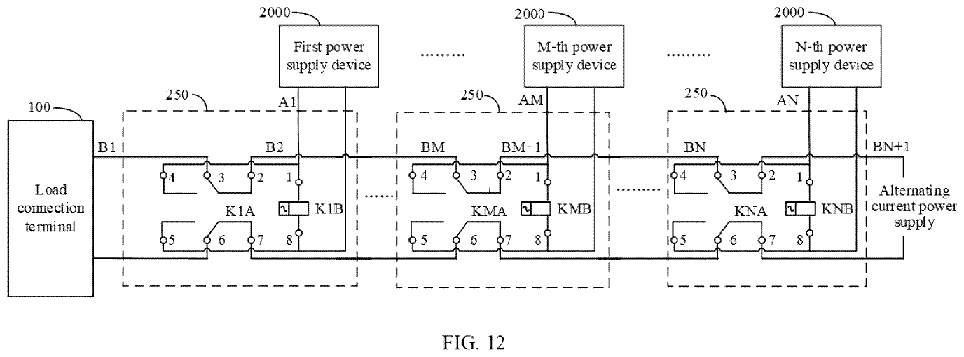

In the operation of the step S31, referring to FIG. 12, the control unit 300 may control the contacts 2 and 3 of each of the switches K1A to KNA to be electrically connected to each other, and the contacts 5 and 7 of each of the switches K1A to KNA to be electrically connected to each other. That is, each of the first power supply device 2000 to the N-th power supply device 2000 is electrically disconnected from the load connection terminal 100.

When the contacts 2 and 3 of each of the switches K1A to KNA are electrically connected to each other and the contacts 5 and 7 of each of the switches K1A to KNA are electrically connected to each other, the node B1 is electrically connected to the node BN+1. That is, the electrical connection between the power grid connection terminal 240 and the load connection terminal 100 can be realized, to cause the power grid to supply power to the load.

The connector 1000 and the power supply device 2000 may be applied in a microgrid system or in other power supply systems 10000. In some embodiments, the power supply device 2000 may be a photovoltaic power generation device or a diesel power generator.

In some embodiments, a priority of the photovoltaic power generation device may be set to be greater than a priority of the diesel power generator. That is, the photovoltaic power generation device may be set as the X-th power supply device 2000, and the diesel power generator may be set as the Y-th power supply device 2000, where X is smaller than Y.

During daytime, the power supply quantity of the photovoltaic power generation device is greater than or equal to the predetermined power supply quantity. In this case, the photovoltaic power generation device supplies power to the load, while the diesel power generation device does not supply power to the load. At night, the power supply quantity of the photovoltaic power generation device is smaller than the predetermined power supply, and the power supply of the diesel power generation device is greater than or equal to the predetermined power supply quantity. In this case, the diesel power generation device supplies power to the load. Assuming that the power supply quantity of each of the photovoltaic power generation device and the diesel power generation device is smaller than the predetermined power supply quantity, the power grid can supply power to the load.

Embodiment of the present disclosure provides a connector 1000, a power supply system 10000, and a control method. The power supply system 10000 includes multiple power supply devices 2000 and a connector 1000. The power supply device 2000 may be a photovoltaic power generation device or a diesel power generator. The power supply system 10000 may be a microgrid system. The connector 1000 includes a load connection terminal 100 and a selection unit 200. The selection unit 200 includes an output terminal 210 and multiple input terminals 220. Each of the multiple power supply devices 2000 is connected to a corresponding one of the multiple input terminals 220. The output terminal 210 is connected to the load connection terminal 100. The selection unit 200 enables a selection of at most one of the multiple input terminals 220 to be electrically connected to the output terminal 210, to cause at most one of the multiple power supply devices 2000 to supply power to the load through the selection unit 200.

When two or more power supply devices 2000 are simultaneously connected to the corresponding input terminals 220, respectively, the power supply devices 2000 may be coupled to each other, that is, one power supply device 2000 may supply power to another power supply device 2000, which may cause a safety hazard of electric leakage. Since the selection unit 200 is configured to select at most one input terminal 220 to be electrically connected to the output terminal 210, the load connection terminal 100 cannot be simultaneously connected to the multiple power supply devices 2000. In addition, the input terminals 220 may be electrically insulated by an insulation material, which avoids mutual coupling between the power supply devices 2000, and reduces a safety hazard of electric leakage of the power supply system 10000.

In the description of this specification, descriptions with reference to the terms “an embodiment”, “some embodiments”, “an exemplary embodiment”, “an example”, “a specific example”, or “some examples” etc., mean that specific features, structure, materials or characteristics described in conjunction with the embodiment or example are included in at least one embodiment or example of the present disclosure. The appearances of the above phrases in various places throughout this specification are not necessarily referring to the same embodiment or example of the present disclosure. In addition, different embodiments or examples and features of different embodiments or examples described in the specification may be combined by those skilled in the art without mutual contradiction.

In addition, the technical terms “connected” should be understood broadly, such as a fixed connection or a detachable connection or connection as one piece; direct connection or indirect connection through an intermediate; internal communication of two components. For those skilled in the art, the specific meaning of the above-mentioned terms in the embodiments of the present disclosure may be understood according to specific circumstances.

In addition, terms such as “first” and “second” are used herein for purposes of description and are not intended to indicate or imply relative importance and are not intended to indicate the number of the technical features. Furthermore, the feature defined with “first” and “second” may include one or more feature distinctly or implicitly. In the description of the present disclosure, “multiple” means at least two, such as two and three, unless specified otherwise.

Any process or method described in a flow chart or described herein in other ways may be understood to include one or more modules, segments or portions of codes of executable instructions for achieving specific logical functions or steps in the process. The scope of the preferred embodiment of the disclosure includes additional implementations in which the functions may be performed not in the order shown or discussed, including in a substantially simultaneous manner or in reverse order according to the functions involved, which should be understood by a person skilled in the technical field to which the embodiments of the disclosure belong.

Although embodiments of present disclosure have been shown and described above, it should be understood that above embodiments are just explanatory, and cannot be construed to limit the present disclosure, for those skilled in the art, changes, modifications, replacements and variants can be made to the embodiments without departing from the scope of the present disclosure.

What is claimed is:

1. A connector for a power supply system, the power supply system comprising a plurality of power supply devices, and the connector comprising:
a load connection terminal configured to be connected to a load; and
a selection unit comprising a plurality of input terminals and an output terminal, each of the plurality of power supply devices being connected to a corresponding one of the plurality of input terminals, the plurality of input terminals being electrically insulated from each other, the output terminal being connected to the load connection terminal, and the selection unit being configured to select at most one of the plurality of input terminals to be in conduction with the output terminal, to cause at most one of the plurality of power supply devices to supply power to the load through the selection unit.

2. The connector according to claim 1, wherein:
the selection unit further comprises a plurality of mutually exclusive switches, each of the plurality of input terminals being connected to the output terminal by a corresponding one of the plurality of mutually exclusive switches; and
the connector further comprises a control unit configured to control at most one of the plurality of mutually exclusive switches to be turned on, to cause at most one of the plurality of input terminals to be in conduction with the output terminal and cause at most one of the plurality of power supply devices to supply power to the load through the selection unit.

3. The connector according to claim 2, wherein the selection unit further comprises a power grid connection terminal configured to be connected to a power grid, wherein:
in response to all of the plurality of mutually exclusive switches being turned off, the power grid connection terminal is in conduction with the load connection terminal; and
the control unit is further configured to control all of the plurality of mutually exclusive switches to be turned off, to cause the power grid connection terminal to be in conduction with the load connection terminal and cause the power grid to supply power to the load through the selection unit.

4. The connector according to claim 3, wherein the plurality of mutually exclusive switches comprise N single pole double throw switches, N being a positive integer greater than 1, the N single pole double throw switches comprising single pole double throw switches S1 to SN, and each of the N single pole double throw switches comprising a first terminal, a second terminal, and a third terminal, wherein:
the first terminal of the single pole double throw switch S1 is connected to a corresponding one of the plurality of input terminals, the second terminal of the single pole double throw switch S1 is connected to the output terminal, and the third terminal of the single pole double throw switch S1 is connected to the second terminal of the single pole double throw switch S2;
the first terminal of the single pole double throw switch SN is connected to a corresponding one of the plurality of input terminals, the second terminal of the single pole double throw switch SN is connected to the third terminal of the single pole double throw switch SN−1, and the third terminal of the single pole double throw switch SN is connected to the power grid connection terminal;
the first terminal of the single pole double throw switch SM is connected to a corresponding one of the plurality of input terminals, the second terminal of the single pole double throw switch SM is connected to the third terminal of the single pole double throw switch SM−1, the third terminal of the single pole double throw switch SM is connected to the second terminal of the single pole double throw switch SM+1, M being a positive integer greater than 1 and smaller than N; and
the control unit is further configured to control each of the N single pole double throw switches to make the second terminal be in conduction with the first terminal or the third terminal.

5. A power supply system, comprising a plurality of power supply devices and a connector, wherein the connector comprises:
a load connection terminal configured to be connected to a load; and
a selection unit comprising a plurality of input terminals and an output terminal, each of the plurality of power supply devices being connected to a corresponding one of the plurality of input terminals, the plurality of input terminals being electrically insulated from each other, the output terminal being connected to the load connection terminal, and the selection unit being configured to select at most one of the plurality of input terminals to be in conduction with the output terminal, to cause at most one of the plurality of power supply devices to supply power to the load through the selection unit.

6. The power supply system according to claim 5, wherein:
the selection unit further comprises a plurality of mutually exclusive switches, each of the plurality of input terminals being connected to the output terminal by a corresponding one of the plurality of mutually exclusive switches; and
the connector further comprises a control unit configured to control at most one of the plurality of mutually exclusive switches to be turned on, to cause at most one of the plurality of input terminals to be in conduction with the output terminal and cause at most one of the plurality of power supply devices to supply power to the load through the selection unit.

7. The power supply system according to claim 6, wherein the selection unit further comprises a power grid connection terminal configured to be connected to a power grid, wherein:
in response to all of the plurality of mutually exclusive switches being turned off, the power grid connection terminal is in conduction with the load connection terminal; and
the control unit is further configured to control all of the plurality of mutually exclusive switches to be turned off, to cause the power grid connection terminal to be in conduction with the load connection terminal and cause the power grid to supply power to the load through the selection unit.

8. The power supply system according to claim 7, wherein the plurality of mutually exclusive switches comprise N single pole double throw switches, N being a positive integer greater than 1, the N single pole double throw switches comprising single pole double throw switches S1 to SN, and each of the N single pole double throw switches comprising a first terminal, a second terminal, and a third terminal, wherein:
the first terminal of the single pole double throw switch S1 is connected to a corresponding one of the plurality of input terminals, the second terminal of the single pole double throw switch S1 is connected to the output terminal, and the third terminal of the single pole double throw switch S1 is connected to the second terminal of the single pole double throw switch S2;
the first terminal of the single pole double throw switch SN is connected to a corresponding one of the plurality of input terminals, the second terminal of the single pole double throw switch SN is connected to the third terminal of the single pole double throw switch SN−1, and the third terminal of the single pole double throw switch SN is connected to the power grid connection terminal;
the first terminal of the single pole double throw switch SM is connected to a corresponding one of the plurality of input terminals, the second terminal of the single pole double throw switch SM is connected to the third terminal of the single pole double throw switch SM−1, the third terminal of the single pole double throw switch SM is connected to the second terminal of the single pole double throw switch SM+1, M being a positive integer greater than 1 and smaller than N; and
the control unit is further configured to control each of the N single pole double throw switches to make the second terminal be in conduction with the first terminal or the third terminal.

9. The power supply system according to claim 5, wherein each of the plurality of power supply devices is a photovoltaic power generation device or a diesel power generation device.

10. The power supply system according to claim 6, wherein each of the plurality of power supply devices is a photovoltaic power generation device or a diesel power generation device.

11. The power supply system according to claim 7, wherein each of the plurality of power supply devices is a photovoltaic power generation device or a diesel power generation device.

12. The power supply system according to claim 8, wherein each of the plurality of power supply devices is a photovoltaic power generation device or a diesel power generation device.

13. A control method for a power supply system, wherein the power supply system comprises a plurality of power supply devices and a connector, wherein the connector comprises a load connection terminal and a selection unit, wherein the selection unit comprises a plurality of input terminals and an output terminal, each of the plurality of power supply devices being connected to a corresponding one of the plurality of input terminals, the plurality of input terminals being electrically insulated from each other, and the output terminal being connected to the load connection terminal, and wherein the control method comprises:
controlling at most one of the plurality of input terminals to be in conduction with the output terminal, to cause at most one of the plurality of power supply devices to supply power to a load through the selection unit.

14. The control method according to claim 13, wherein the selection unit further comprises a power grid connection terminal configured to be connected to a power grid, and in response to all of the plurality of input terminals being not in conduction with the output terminal, the power grid connection terminal is in conduction with the load connection terminal, wherein the control method further comprises:
controlling each of the plurality of input terminals to be not in conduction with the output terminal, to cause the power grid to supply power to the load through the selection unit.

15. The control method according to claim 14, further comprising:
obtaining a power supply priority of each of the plurality of power supply devices;
sequentially obtaining, based on the power supply priority of each of the plurality of power supply devices, a power supply quantity of each of the plurality of power supply devices until a target power supply device is determined, wherein the power supply device, with the power supply quantity greater than or equal to a predetermined power supply quantity, is determined as the target power supply device; and
controlling, in response to that the target power supply device is determined, one of the plurality of input terminals corresponding to the target power supply device to be in conduction with the output terminal, to cause the target power supply device to supply power to the load through the selection unit.

16. The control method according to claim 14, further comprising:
obtaining a power supply quantity of each of the plurality of power supply devices;
determining, when the power supply quantity of each of the plurality of power supply devices is smaller than a predetermined power supply quantity, that each of the plurality of power supply devices is not a target power supply device; and
controlling, in response to that each of the plurality of power supply devices is determined not to be the target power supply device, each of the plurality of input terminals to be not in conduction with the output terminal, to cause the power grid to supply power to the load through the selection unit.
